(19) United States
(12) Patent Application Publication
(10) Pub. No.: US 2014/0265971 A1
(43) Pub. Date: Sep. 18, 2014

(54) Battery Charger/Export Power

(71) Applicant: KOLLMORGEN CORPORATION, Radford, VA (US)

(72) Inventors: Peter TAUBE, Gibsonia, PA (US); Gerald W. BROWN, Radford, VA (US)

(73) Assignee: KOLLMORGEN CORPORATION, Radford, VA (US)

(21) Appl. No.: 13/794,953

(22) Filed: Mar. 12, 2013

(51) Int. Cl. H02P 6/00

(52) U.S. Cl. CPC H02P 6/001
USPC 318/400.41

(57) ABSTRACT

A system for providing operating or charging current supply in different modes of operation includes an electric machine including a rotor and a stator having stator windings, at least one charge storage device, such as a battery, and an inverter disposed between the charge storage device terminals and the electric machine. A contact arrangement modifies electrical interconnections between phases of the inverter and the stator windings. In a supply mode, the electrical interconnections are controlled so that each inverter phase is electrically interconnected with a stator winding set having windings separated from each other by stator windings in other winding sets for driving the rotor of the electrical machine. In a charge mode, however, these interconnections are controlled so that each inverter phase is electrically interconnected with a stator winding set having windings directly adjacent to each other and are not separated from each other.

### BACKGROUND OF THE INVENTION

1. Field of the Invention

The present invention concerns systems using permanent magnet motors as three phase inductors for export power and battery charging for use with electric vehicles, diesel/electric vehicles, and other types of hybrid electric vehicles.

2. Description of Related Art

When a traction motor and an inverter are used for battery charging and export power, the traction motor operates as an inductor, and the inverter performs bi-directional conversion, such that DC/AC conversion is performed for export power, and AC/DC conversion is performed for battery charging. Conventionally, to do this, a grid point is connected to the Y-point on the motor. One problem with typical arrangements is the requirement for three motors and three inverters for a three phase grid connection. In electric vehicle charging applications, large, expensive chargers are typically required, and extra equipment that is both costly and bulky is needed.

One electrical apparatus including a drive system and an electrical machine with a stator winding connectable to a three phase network is disclosed by International PCT Publication WO 2011/159241 A1 to Alaküla et al. Other apparatuses and systems that may be of interest form the subject matter of U.S. Pat. No. 4,920,475 to Rippel, U.S. Pat. No. 5,099,186 to Rippel et al., U.S. Pat. No. 5,341,075 to Cocconi, U.S. Patent Application Publication 2012/0194030 A1 to Brown et al., and Japanese Patent Publication 10-248172 to Tsutomu et al. The disclosures of the Rippel ('475) patent, the Rippel et al. ('186) patent, and the Cocconi ('075) patent are all incorporated herein by reference in their entireties as non-essential subject matter.

### SUMMARY OF THE INVENTION

One general aspect of this invention concerns applications of a permanent magnet motor as a three phase inductor with motor windings. Other aspects concern use of certain connection architecture, use of a pole count mismatch and an inverter in various application modes, and the possible use of a variety of motor types.

To use a traction motor and inverter as a battery charger or as a DC/AC export power module in a vehicle of the sort referred to above, it is recognized according to the invention that it is possible to use a six pole machine, but switch, with contactors, the stator to a four pole motor, creating a pole-count mismatch between the rotor and stator. One benefit of this feature is that the motor can be used as a three-phase inductor without rotating or producing any torque, and only one inverter is needed. Such an arrangement would also increase inductance as compared to the three motor solution mentioned, since the flux would be linked. Benefits of the present invention could be significant, as an expensive charger could be eliminated, or a diesel electric vehicle could export all its power without any extra equipment, weight, or space beyond what the contactors would require.

An alternative solution would be to break up the neutral point on a permanent magnet motor, and directly connect each winding to each phase on the grid. Due to the high grid frequency (50/60 Hz), the permanent magnet motor will not lock on to the rotating magnetic field, and will therefore produce very low or even zero torque. If a small torque is produced and constitutes a problem for a specific application, a simple on-off brake can be used to eliminate that problem.

According to one preferred embodiment of the invention, a system for providing operating current supply and charging current supply in different modes of operation includes an electric machine including a rotor and a stator having stator windings, at least one charge storage device, such as a battery, or in certain applications, capacitors with a neutral point therebetween that is electrically interconnectable with a neutral wire, and an inverter disposed between the charge storage device terminals and the electric machine. The motor stator includes a plurality of windings, and a contact arrangement is disposed so as to modify electrical interconnections between the inverter and the windings, changing the pole count in the stator. In a supply mode, the electrical interconnections mentioned are controlled using the contact arrangement so that each inverter phase is electrically interconnected with a stator winding set having windings separated from each other by a plurality of stator windings in other winding sets for driving the rotor of the electrical machine. In a charge mode, by contrast, these interconnections are controlled with the contact arrangement so that each inverter phase is electrically interconnected with a stator winding set having windings that are directly adjacent to each other and are not separated from each other. The windings that are directly adjacent to each other, in one arrangement, are connected in parallel in the charge mode. Each inverter phase, in the charge mode, accordingly can receive current supplied from an external source through the stator windings for charging the charge storage device through the inverter.

In certain arrangements, the contact arrangement is disposed between the electric machine and the inverter. The current received by the windings may be supplied from either a polyphase external source, with or without a neutral wire, or a single phase external source. The rotor could be either a permanent magnet rotor, including, for example, six poles, or another rotor appropriate for use in a motor of some other type. In one arrangement suitable for power export, a further inverter can be disposed between the charge storage device terminals and a further electric machine, such as a vehicle battery charging station. A process for providing operating current supply and charging current supply in different modes of operation is also described.

### BRIEF DESCRIPTION OF THE DRAWINGS

FIG. 1 is a schematic illustration of one embodiment of a system according to the invention when configured for operation in a motor mode.

FIG. 2 is a schematic illustration of a rotor and stator winding arrangement for the motor of the system shown in FIG. 1.

FIG. 3 is a schematic illustration of the system when configured for operation in a battery charging mode.

FIG. 4 is an illustration similar to FIG. 2 but showing the manner in which windings are grouped into winding sets during battery charging.

FIG. 5 is a schematic illustration of the system when configured for operation in a battery charging mode suitable for use in conjunction with a single phase AC system.

FIG. 6 is a schematic illustration of the system when used in an export power mode and in conjunction with a polyphase AC system having a neutral wire connection.

FIG. 7 is a schematic illustration of the system when configured for operation together with a motor of a type other than that associated with the arrangements of FIGS. 1-6.

### DETAILED DESCRIPTION OF THE INVENTION

FIG. 1 illustrates a system 10 according to the invention when configured for operation in a supply mode, also referred to as a motor mode. The system 10 shown includes a charge storage device, here configured as a direct current (DC) battery 12, a voltage transient damping input capacitor 14 connected over the DC bus, and a three phase DC/AC inverter 16. As shown, one terminal of the battery 12 is interconnected by way of a line 18 to the inverter 16, while the other terminal of the battery 12 is interconnected by way of a line 19 to the inverter 16. The inverter 16 includes pairs of switch elements, such as the transistors 20 and 26, 22 and 28, and 24 and 30 illustrated. At a junction 32, 34, or 36 defining an inverter phase, each switch element 20, 22, and 24 of a respective switch element pair is respectively interconnected to the other switch element 26, 28, and 30 of that switch element pair in typical fashion.

A first connection or lead 38 electrically interconnects with the junction 36, a second connection or lead 40 electrically interconnects with the junction 34, and a third connection or lead 42 electrically interconnects with the junction 32 to enable the inverter 16 to supply current to appropriate windings of an electric machine, which, here, is configured as a motor 44. The motor 44 of this arrangement utilizes a six pole permanent magnet rotor 64 rotatable within a stator 45 supporting nine windings, as indicated in FIG. 2.

Each switch of a set of solid state switches (contactors) 46, 48, 50, 52, 54, and 56, as well as each of the grid connection switches 58, 60, and 62, is placed by an appropriate control device (not shown), or by several such control devices, into its proper position in each of the operating modes to be discussed. The switches 46, 48, 50, 52, 54, and 56, collectively, constitute at least part of a contact arrangement disposed so as to modify electrical interconnections between the inverter 16 and the stator windings U1-U3, V1-V3, and W1-W3, as will be described. In the motor mode represented in FIG. 1, the switches 58, 60, and 62 are open to isolate the system 10 electrically from an external alternating current (AC) power source, to which the illustrated U Grid, V Grid, and W Grid lines lead. Switches 46, 48, 50, 52, 54, and 56 are positioned by the control device so that AC current is supplied from the inverter 16 by way of the leads 38, 40, and 42 to all windings U1-U3, V1-V3, and W1-W3 of the motor 44, with the lead 38 supplying current to the windings U1, U2, and U3, the lead 40 supplying current to the windings V1, V2, and V3, and the lead 42 supplying current to the windings W1, W2, and W3. Referring to both FIG. 1 and FIG. 2, it will be seen that, in the supply mode, the contact arrangement including the switches 46, 48, 50, 52, 54, and 56 is controlled so that each inverter phase, such as the phase 32, is electrically interconnected with a respective stator winding set, e.g. W1-W3, having windings W1-W3 separated from each other by a plurality of stator windings in other winding sets U1-U3 and V1-V3 for driving the rotor of the electrical machine. Current supplied to the windings U1-U3, V1-V3, and W1-W3 produces rotation of the rotor 64 in the usual manner.

FIG. 3 illustrates the system 10 when configured by the control device for operation in one type of charge mode, also referred to as a battery charging mode. In the battery charging mode shown, the switches 58, 60, and 62 are closed, and, by way of respective winding sets of the motor 44, the system 10 is interconnected with a three phase external AC power source, to which the illustrated U Grid, V Grid, and W Grid lines lead. In particular, the windings U1, V1, and W1 of a first motor winding set electrically connect in parallel by way of switches 46 and 48, positioned by the control device, to the U Grid line. Similarly, the windings U2, V2, and W2 of a second winding set electrically connect in parallel by way of switches 50 and 52 to the V Grid line, and the windings U3, V3, and W3 of a third winding set electrically connect in parallel by way of switches 54 and 56 to the W Grid line. FIG. 4 schematically illustrates the disposition of the three winding sets mentioned about the stator 45.

By way of the first connection or lead 38, each winding U1, V1, and W1 of the first winding set electrically interconnects with the inverter phase defined by the junction 36. Similarly, by way of the second connection or lead 40, each winding U2, V2, and W2 of the second winding set electrically interconnects with the inverter pole defined by the junction 34, and, by way of the third connection or lead 42, each winding U3, V3, W3 of the third winding set electrically interconnects with the inverter pole defined by the junction 32. The switch elements 20, 22, 24, 26, 28, and 30 of the inverter 16, with its associated capacitor 14, are operated by the control unit to permit appropriate DC flow on the line 18 or 19 and charge the battery 12. Referring now to both FIG. 3 and FIG. 4, it will be seen that in the charge mode shown, the contact arrangement including the switches 46, 48, 50, 52, 54, and 56 is controlled so that each inverter phase, such as the phase 32, is electrically interconnected with a respective stator winding set, e.g. U3, V3, W3, having windings U3, V3, W3 that are directly adjacent to each other and are not separated from each other for receiving current supplied from the three phase external power source through the stator winding set and charging the battery 12 through the inverter.

The system 10 is shown in FIG. 5 in a charge mode for use in conjunction with a single phase AC system appropriate for household applications. Here, the switch 58 is closed by the control device to electrically interconnect the U Grid and the windings U1, V1, and W1 of the first winding set, in parallel, to the inverter phase defined by the junction 36, while a switch 66 is closed to electrically interconnect the inverter phase defined by the junction 34 with neutral (N) by way of the windings U2, V2, and W2, in parallel. The switch 62 is open, rendering the windings U3, V3, and W3 inoperative. The switches 46, 48, 50, 52, 54, and 56, as illustrated, are positioned identically here and in the battery charging mode used in conjunction with the three phase external AC power source represented in FIG. 3. Appropriate operation of the inverter switch elements 20, 22, 24, 26, 28, and 30 by the control unit permits DC flow on the line 18 or 19 to charge the battery 12, while the junction 34 and the windings U2, V2, and W2, again, serve as neutral connections.

As illustrated in FIG. 6, the system 10 is used in an export power mode in conjunction with a three phase AC system having a neutral wire connection N Grid. In the export power mode, the power limitation will be the normal rating of the motor and the inverter. The stator thickness needs to match a four pole motor instead of a six pole motor for full power. Here, as in the battery charging mode shown in FIG. 3, the switches 58, 60, and 62 are closed, and the switches 46, 48, 50, 52, 54, and 56 electrically connect windings of respective sets of parallel windings U1, V1, and W1, U2, V2, and W2, and U3, V3, and W3 to connections or leads 38, 40, and 42, and hence to the phases 36, 34, and 32, respectively, of the inverter 16. The battery 12 and the capacitor 14 internal to the inverter that are included in the arrangement of FIG. 3 are replaced here by a charge storage device at least including capacitors 70, 72, with a neutral point 76 there between, which is electrically connected by a conductor 74 with a further switch 66, and, as the switch 66 is closed, to the neutral wire connection of the three phase AC system.

The lines 18 and 19 here electrically interconnect the inverter 16 with appropriate terminals of the capacitors 70, 72 as well as to an additional DC/AC inverter 78, including pairs of switch elements, such as the transistors 80 and 86, 82 and 88, and 84 and 90 illustrated. A first connection or lead 92 electrically interconnects a junction 94 forming a pole of the inverter 78 to certain stator windings (not shown) of another electric machine, which, here, is a generator 96. Similarly, a second connection or lead 98 electrically interconnects a junction 100 to respective stator windings of the generator, while a third connection or lead 102 electrically interconnects a junction 104 with further generator stator windings. A mechanical shaft 106 may be used to interconnect the generator 96 and a diesel engine 110.

FIG. 7 illustrates the battery charger and export power system 10 when configured for operation in a motor mode together with a schematically illustrated motor 116 of a type that differs from the motor 44. Additional switches 112, 114 are provided here to short selected stator coils. The system shown in FIG. 7 is similar otherwise to the arrangements described previously, and includes, inter alia, a DC battery 12, a voltage transient damping input capacitor 14 internal to a three phase inverter 16, connections or leads 38, 40, and 42 associated with respective inverter phases, and switches 58, 60, and 62 that can be selectively closed or opened, as shown, to connect the system 10 electrically to or isolate the system 10 electrically from U Grid, V Grid, and W Grid lines leading to the external AC power source.

The foregoing disclosure has been set forth merely to illustrate the invention and is not intended to be limiting. Modifications of the disclosed embodiments incorporating the spirit and substance of the invention may occur to persons skilled in the art, and the invention should be construed to include everything within the scope of the invention ultimately claimed.

1. A system for providing operating current supply and charging current supply in different modes of operation, comprising:
an electric machine including a rotor and a stator having stator windings,
at least one charge storage device including charge storage device terminals,
an inverter disposed between the charge storage device terminals and the electric machine, the inverter including a plurality of inverter phases, and
a contact arrangement disposed so as to modify electrical interconnections between the inverter and the stator windings,
wherein the contact arrangement is controllable so that each inverter phase is electrically interconnected with a stator winding set having windings separated from each other by a plurality of stator windings in other winding sets in a supply mode for driving the rotor of the electrical machine, and so that each inverter phase is electrically interconnected with a stator winding set having windings that are directly adjacent to each other and are not separated from each other in a charge mode for receiving current supplied from an external source through the stator windings and charging the charge storage device through the inverter.

2. The system of claim 1, wherein the contact arrangement is disposed between the electric machine and the inverter and modifies electrical interconnections between the inverter phases and the stator windings.

3. The system of claim 1, wherein the current received by the windings is supplied from a polyphase external source.

4. The system of claim 1, wherein the current received by the windings is supplied from a single phase external source.

5. The system of claim 1, wherein the rotor is a permanent magnet rotor.

6. The system of claim 5, wherein the rotor has six poles.

7. The system of claim 1, wherein the electric machine is a permanent magnet motor.

8. The system of claim 1, further comprising a further electric machine and a further inverter disposed between the charge storage device terminals and the further electric machine.

9. The system of claim 8, wherein the current received by the windings is supplied from a polyphase external source having a neutral wire.

10. The system of claim 9, wherein the charge storage device includes capacitors with a neutral point therebetween that is electrically interconnectable with the neutral wire.

11. The system of claim 1, wherein the windings that are directly adjacent to each other are connected in parallel in the charge mode.

12. The system of claim 8, wherein the further electric machine is a vehicle battery charging station.

13. A process for providing operating current supply and charging current supply in different modes of operation by way of a system having an electric machine including a rotor and a stator having stator windings, at least one charge storage device including charge storage device terminals, an inverter disposed between the charge storage device terminals and the electric machine, the inverter including a plurality of inverter phases, and a contact arrangement disposed so as to modify electrical interconnections between the inverter and the stator windings, the process comprising:
driving the rotor of the electrical machine in a supply mode by controlling the contact arrangement so that each inverter phase is electrically interconnected with a stator winding set having windings separated from each other by a plurality of stator windings in other winding sets, and
charging the charge storage device through the inverter in a charge mode by controlling the contact arrangement so that each inverter phase is electrically interconnected with a stator winding set having windings that are directly adjacent to each other and are not separated from each other for receiving current supplied from an external source through the stator windings.

14. The process of claim 13, wherein the contact arrangement is disposed between the electric machine and the inverter, and further comprising modifying electrical interconnections between the inverter phases and the stator windings by way of the contact arrangement.

15. The process of claim 13, wherein receiving the current includes receiving current supplied from a polyphase external source.

16. The process of claim 13, wherein receiving the current includes receiving current supplied from a single phase external source.

17. The process of claim 13, wherein the rotor is a permanent magnet rotor.

18. The process of claim 17, wherein the rotor has six poles.

19. The process of claim 13, wherein the electric machine is a permanent magnet motor.

20. The process of claim 13, further comprising disposing a further inverter between the charge storage device terminals and a further electric machine.
